(19) United States
(12) Patent Application Publication
(10) Pub. No.: US 2016/0011623 A1
(43) Pub. Date: Jan. 14, 2016

(54) PROCESSOR STATE CONTROL BASED ON DETECTION OF PRODUCER/CONSUMER WORKLOAD SERIALIZATION

(71) Applicant: Intel Corporation, Santa Clara, CA (US)

(72) Inventors: Guy M. Therien, Beaverton, OR (US); Doron Rajwan, Rishon Le-Zion (IL)

(73) Assignee: Intel Corporation, Santa Clara, CA (US)

(21) Appl. No.: 14/326,529

(22) Filed: Jul. 9, 2014

(51) Int. Cl. G06F 1/08

(52) U.S. Cl. CPC G06F 1/08

(57) ABSTRACT

Generally, this disclosure provides systems, devices, methods and computer readable media for controlling the processor state (e.g., the clock frequency) of processors based on detection of producer/consumer workload serialization across the processors. The system may include a utilization measurement module configured to measure utilization of the processors. The system may also include a correlation module configured to estimate a balance between producer/consumer (P/C) workload and non-P/C workload executing on the processors. The system may further include a clock frequency adjustment module configured to calculate a clock frequency adjustment based on the estimated balance and the measured utilization and to update the clock frequency of the processors based on the calculated adjustment.

### FIELD

The present disclosure relates to processor state control, and more particularly, processor state control based on detection of producer/consumer workload serialization across multiple processors.

### BACKGROUND

Computer system processors increasingly offer processor state control capabilities through which the processor voltage and clock frequency may be varied. A higher clock frequency enables faster workload execution but at increased power consumption and heat generation. A tradeoff is typically made between speed and power usage and the clock frequency may be dynamically adjusted to achieve desired results in response to changing conditions and requirements. This is generally referred to as Demand-Based Switching (DBS) of processor states.

In multi-processor or multi-core systems, the workload may be divided between two or more processors, for example as threads. In some cases the threads may be able to execute in a relatively parallel fashion, while in other cases, one thread may need to wait for results from another thread. The later case is often referred to as producer/consumer (P/C) workload serialization, where the consuming thread waits on the producing thread and this may result in decreased processor utilization.

Typically a processor workload may include a mix of P/C and non-P/C workloads. Knowing whether, and to what extent, processor utilization is being affected by P/C workload serialization may be advantageous in making processor state control decisions. Existing solutions have relied on software to explicitly indicate, to the processor state control systems, whether or not threads are P/C oriented. Unfortunately, this presents a burden on the software and on software development which has generally held back progress in this area.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one example embodiment consistent with the present disclosure;

FIG. 2 illustrates a block diagram of an example embodiment consistent with the present disclosure;

FIG. 3 illustrates a flowchart of operations of one example embodiment consistent with the present disclosure;

FIG. 4 illustrates a correlation curve of an example embodiment consistent with the present disclosure;

FIG. 5 illustrates a flowchart of operations of another example embodiment consistent with the present disclosure; and

FIG. 6 illustrates a system diagram of a platform of another example embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems, devices, methods and computer readable media for controlling the processor state, and thus the clock frequency, of processors based on detection of producer/consumer (P/C) workload serialization across the processors. The nature of P/C workloads is that the execution progress of one thread is linked to the execution progress of another thread. P/C workload serialization refers to the situation where a delay is incurred when a thread on one processor waits for results to be provided by another thread on another processor, thus serializing the work to some extent rather than permitting more parallel execution of the threads. P/C workload serialization is one cause of reduced processor utilization due to the idle time associated with the waiting threads. The system may estimate the balance between P/C workload and non-P/C workload executing on multiple threads over multiple processors (or cores).

The balance estimation may be accomplished by measuring changes in processor utilization that accompany a tested change (e.g., increase or decrease) in clock frequency. In the case of a relatively higher P/C workload mix, the utilization will tend to remain relatively unchanged during the period of altered clock frequency. In the case of a relatively lower P/C workload mix, the utilization will tend to decrease, for example, during a period of higher clock frequency. The balance may therefore be estimated by tracking or correlating the measured change in processor utilization with the test change in clock frequency. A clock frequency adjustment module may be configured to calculate a desired change in clock frequency, based on the correlation.

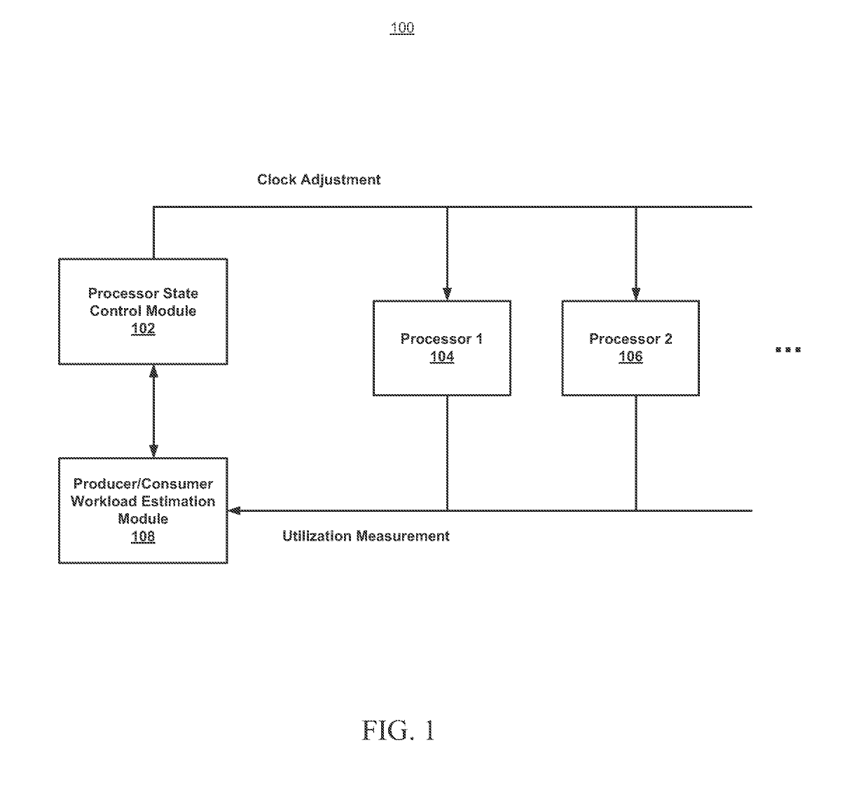

FIG. 1 illustrates a top level system diagram 100 of one example embodiment consistent with the present disclosure. The system is shown to include a number of processors 104, 106, etc., a processor state control module 102 and a Producer/Consumer workload estimation module 108. In some embodiments, the processors may be processor cores or other types of processing units such as, for example, graphics processors (GPUs). Although only two processors are shown for simplicity, any number of processors of any type may be employed and controlled as described herein. It will be appreciated that the techniques described herein may be applied to any collection of devices that have controllable clock frequencies. The system may be part of a device or larger system which may be a any type of computational or communication platform, whether fixed or mobile, including, for example, a smart phone, smart tablet, personal digital assistant (PDA), mobile Internet device (MID), convertible tablet, notebook, laptop computer, workstation, desktop computer or wearable device.

The processor state control module 102 may be configured to adjust the processor state of processors 104, 106, etc. In some embodiments, the processor state may include a pairing of a processor voltage specification/request and a clock frequency specification/request. Higher clock frequencies may enable faster workload execution for some types of workloads (for example, P/C workloads), but generally increase power consumption which is undesirable.

Producer/Consumer workload estimation module 108 may be configured to estimate the mix of P/C workload and non-P/C workload execution across processors and threads, as will be explained in greater detail below. The estimation may then be used to calculate a clock frequency adjustment to be applied by the processor state control module 102 to the processors 104, 106.

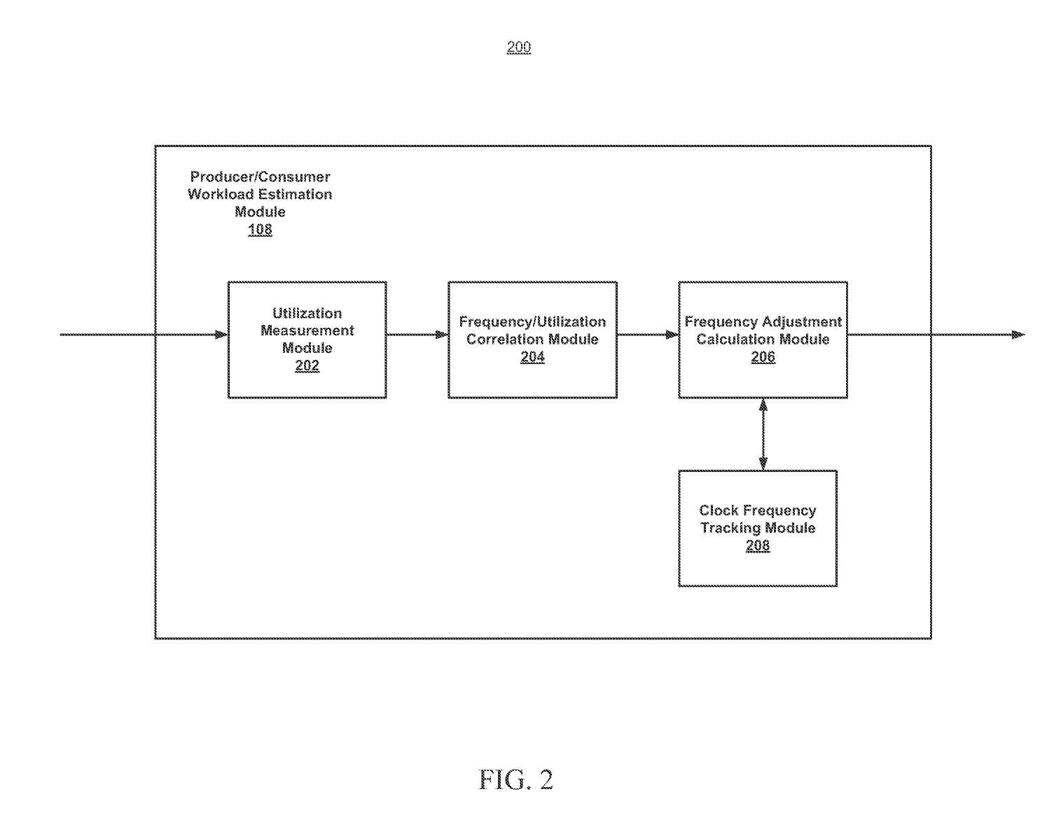

FIG. 2 illustrates a block diagram 200 of an example embodiment consistent with the present disclosure. The Producer/Consumer workload estimation module 108 is shown to include utilization measurement module 202, frequency/utilization correlation module 204, frequency adjustment calculation module 206 and clock frequency tracking module 208.

Generally, when processor demand decreases, the measured processor utilization also decreases because there is less work to do and the processor spends more time in an idle state. Under these conditions, lowering the clock frequencies may be beneficial to save power with little impact on performance. However, a decrease in measured utilization may also result when the workload has a higher percentage of Producer/Consumer threads hosted among different processors, due to the waiting time associated with serialized execution. In this case, however, increasing the clock frequency may improve performance since there is work waiting to be done and a higher clock frequency can decrease those waiting times. Estimating the degree of P/C workload is therefore useful in determining an appropriate clock frequency.

Utilization measurement module 202 may be configured to measure the utilization of each processor as a percentage of time that the processor is not idle. So, for example, a 30% utilization measurement indicates that the processor is doing work 30% of the time and remaining idle 70% of the time. In some embodiments, the measurements may be an average measurement over a suitable period of time. An initial utilization measurement may be performed to determine if the utilization is below a threshold value for which a potential clock frequency increase may be beneficial.

Frequency/utilization correlation module 204 may be configured to determine a relationship between a trial or test clock frequency change and a resulting change in processor utilization. Typically the test clock frequency change may be an increase, as in the description below, but either an increase or decrease may be used for this purpose. If a relatively larger percentage of the work is P/C in nature, the measured utilization will be below 100% due to the serialization effect described previously. An increase in the clock frequency of the cores executing this type of workload will cause the per thread utilization to remain substantially unchanged because even though execution speed is increased, the percentage of time spent waiting for the other thread remains about the same. If, however, the per thread utilization decreases in response to a clock frequency increase, this may indicate that a relatively smaller percentage of the work is P/C in nature. In other words, for non-P/C workloads it takes less time to do the work at higher clock frequencies so the utilization goes down.

As described previously, in some embodiments the test clock frequency change may be a decrease. In this case, if the per thread utilization increases in response to a clock frequency decrease, this may indicate that a relatively smaller percentage of the work is P/C in nature. In other words, for non-P/C workloads it takes more time to do the work at lower clock frequencies so the utilization goes up.

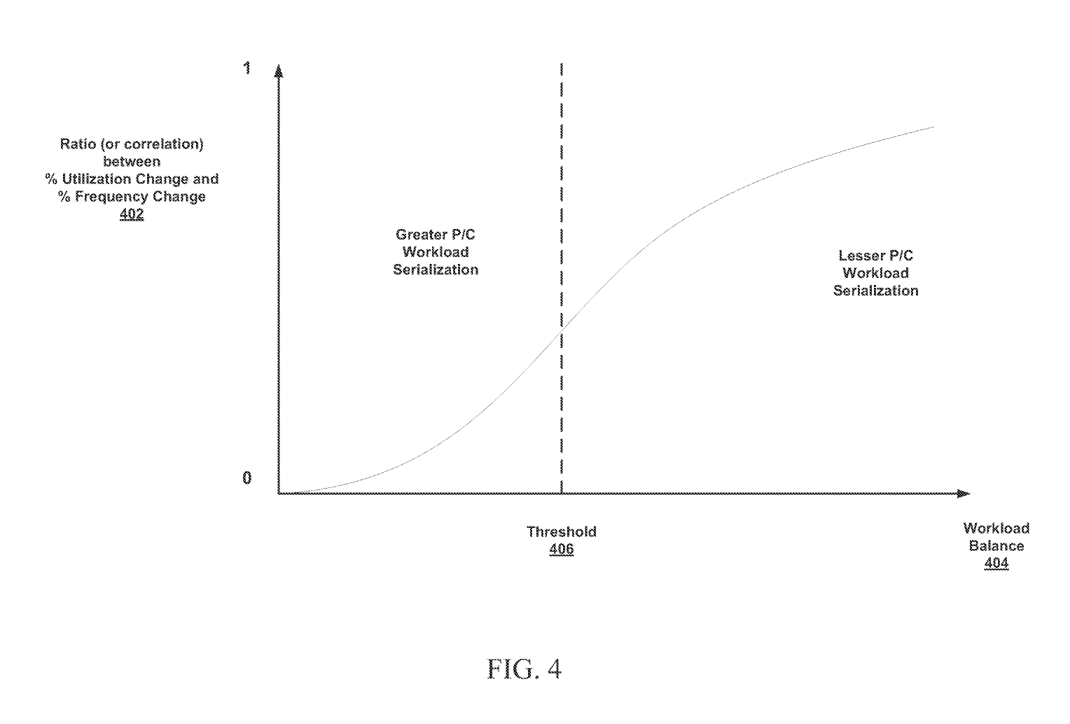

The frequency/utilization correlation module 204 may therefore increase the clock frequency for a period of time during which the balance between P/C workload and non-P/C workload is estimated. The processor utilization may be measured before and after the trial clock increase and a ratio of the utilization change to the clock frequency increase may be calculated. The workload balance estimate may then be based on this ratio or correlation. For example, in some embodiments, the ratio may be compared to a threshold ratio and the workload balance may be estimated as being more P/C oriented if the calculated ratio is less than the threshold ratio, as illustrated in FIG. 4.

The frequency adjustment calculation module 206 may be configured to determine the appropriate clock frequency adjustment based on the calculated ratio. In some embodiments, a calculated ratio below the threshold ratio may result in the selection of the maximum clock frequency. In some embodiments, calculated ratios above the threshold ratio may be mapped to a range of decreasing clock frequencies that are based on a performance versus energy efficiency preference. The mapping function may be provided, for example, by the operating system or firmware.

Clock frequency tracking module 208 may be configured to monitor the clock frequency change history over time. For example, if periodic re-checking of utilization (e.g., re-measuring after an elapsed time interval) indicates that the processor utilization has risen above a threshold value, and the change history indicates that the clock frequency was previously increased, then the clock frequency may be reduced to increase energy efficiency.

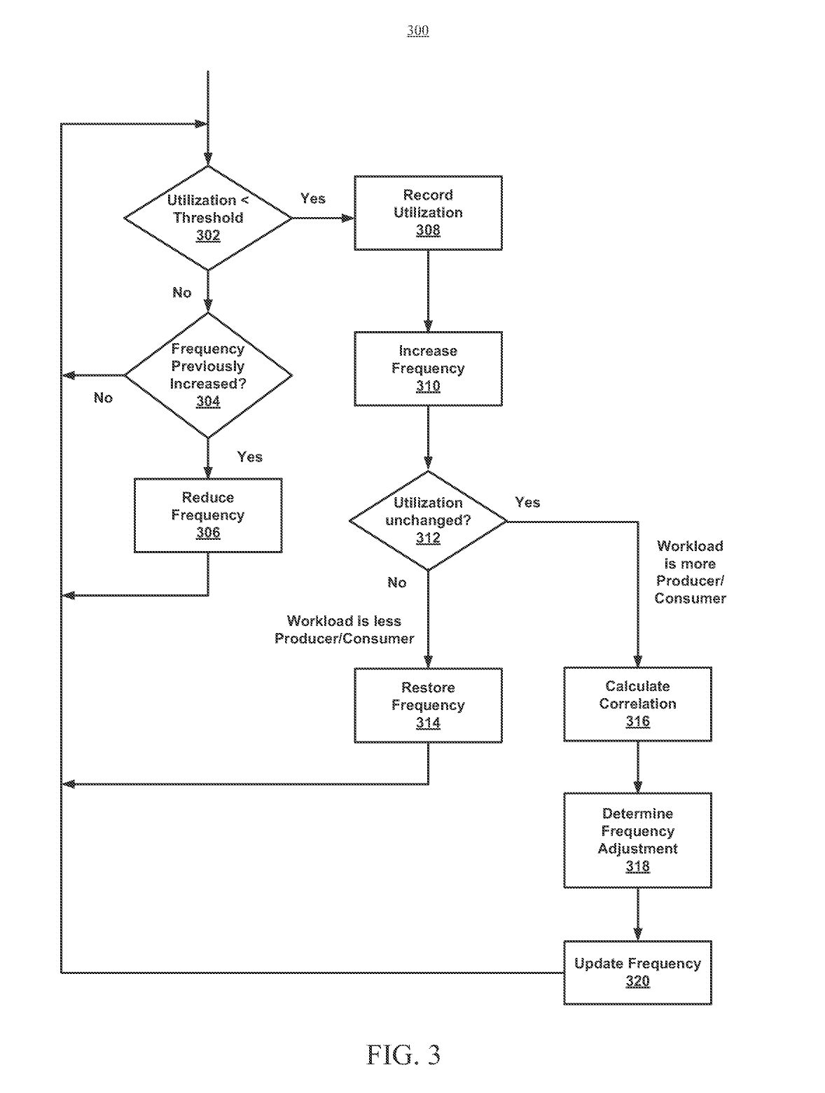

FIG. 3 illustrates a flowchart of operations 300 of another example embodiment consistent with the present disclosure. The operations provide a method for controlling the clock frequency of processors based on detection of producer/consumer workload serialization across the processors. At operation 302, the utilization of multiple threads across multiple processors (or cores) is measured and compared to a utilization threshold. At operation 304, if the utilization is greater than (or equal to) the threshold and the processor clock frequencies were previously increased, then the clock frequencies are reduced after a pre-determined or adjustable time period, at operation 306.

If, however, the measured utilization is less than the threshold, then at operation 308, the utilization is recorded and, at operation 310, the clock frequencies of the processors are increased to begin the estimation of the degree of P/C workload serialization across the processors. If, in response to the clock frequency increase, the utilization changes (decreases), which is measured at operation 312, then the workload is determined to be relatively less P/C oriented and the clock frequency is restored, at operation 314.

Alternatively, if the utilization remains relatively unchanged, then the workload is determined to be relatively more P/C oriented and performance may benefit from an increase in clock frequency. At operation 316, a correlation is calculated between the utilization change and the frequency increase. At operation 318, a clock frequency adjustment is determined based on the calculated correlation and, at operation 320, the clock frequency is updated.

FIG. 4 illustrates a correlation curve 400 of an example embodiment consistent with the present disclosure. The horizontal axis 404 represents the workload balance, ranging from maximum (substantially 100%) P/C workload (and associated serialization) on the left, to minimum (substantially 0%) P/C workload on the right. The vertical axis 402 represents the ratio (or correlation) between the percentage utilization change and the percentage clock frequency change, from zero (no correlation) to 1 (full correlation). The illustrated curve is presented as an example but may conform to any shape and may be empirically determined. A threshold 406 is also shown which may be set to mark a boundary between maximum clock frequency (to the left) and reduced clock frequencies (to the right).

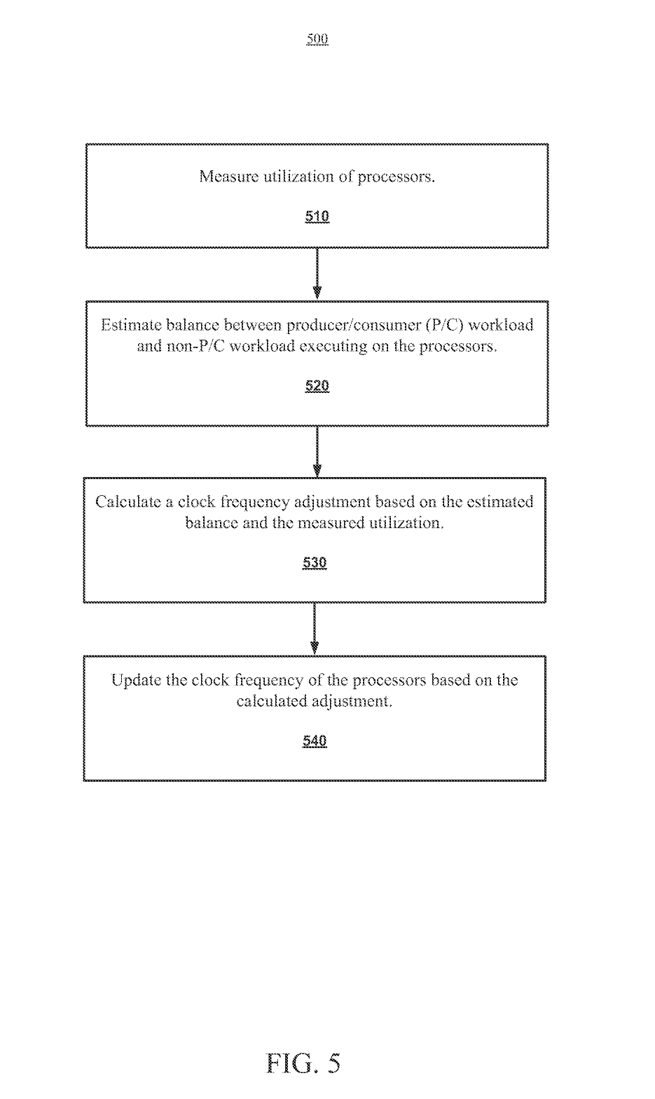

FIG. 5 illustrates a flowchart of operations 500 of another example embodiment consistent with the present disclosure. The operations provide a method for controlling the clock frequency of processors based on detection of producer/consumer workload serialization across the processors. At operation 510, the utilization of the processors is measured. At operation 520, an estimation of the balance between producer/consumer (P/C) workload and non-P/C workload executing on the processors is made. At operation 530, a clock frequency adjustment is calculated based on the estimated balance and the measured utilization. At operation 540, the clock frequency of the processors is updated based on the calculated adjustment.

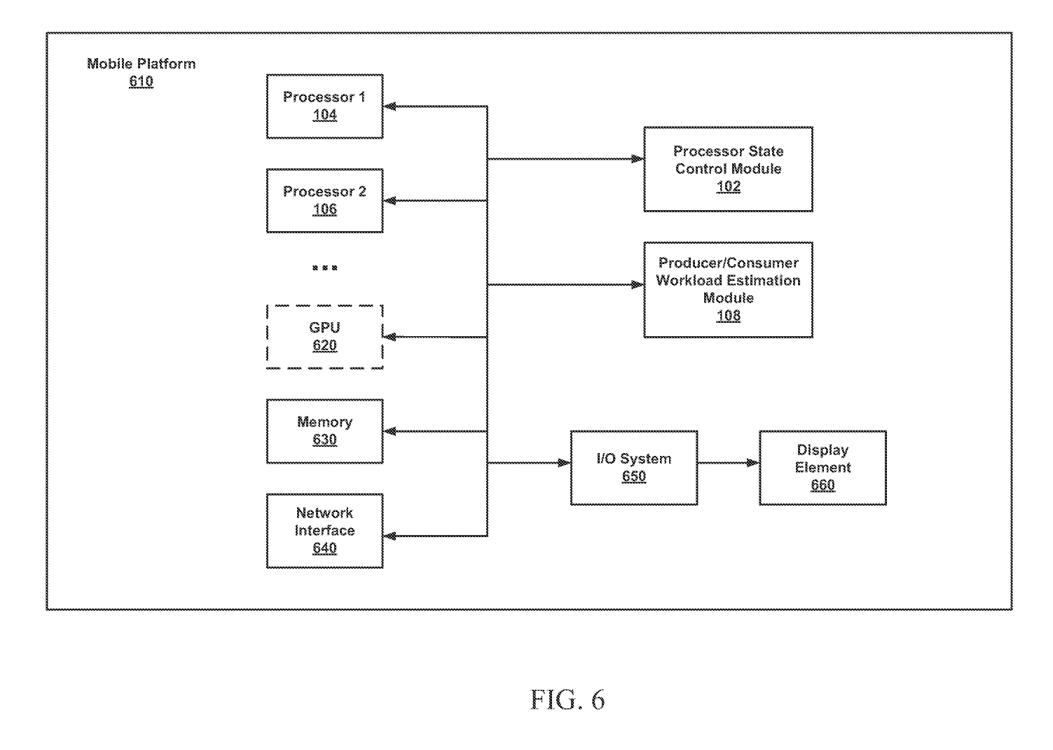

FIG. 6 illustrates a system diagram 600 of one example embodiment consistent with the present disclosure. The system 600 may be a mobile platform 610 or computing device such as, for example, a smart phone, smart tablet, personal digital assistant (PDA), mobile Internet device (MID), convertible tablet, notebook or laptop computer, or any other suitable device. It will be appreciated, however, that embodiments of the system described herein are not limited to mobile platforms, and in some embodiments, the system 600 may be a workstation or desktop computer. The device may generally present various interfaces to a user via a display element 660 such as, for example, a touch screen, liquid crystal display (LCD) or any other suitable display type.

The system 600 is shown to include any number of processors 104, 106, etc., optionally including any number of GPUs 620 or other specialized types of processors. In some embodiments, the processors 104, 106, 620 may be implemented as any number of processor cores. The processor (or processor cores) may be any type of processor, such as, for example, a micro-processor, an embedded processor, a digital signal processor (DSP), a network processor, a field programmable gate array or other device configured to execute code. The processors may be multithreaded cores in that they may include more than one hardware thread context (or “logical processor”) per core. System 600 is also shown to include a memory 630 coupled to the processors. The memory 630 may be any of a wide variety of memories (including various layers of memory hierarchy and/or memory caches) as are known or otherwise available to those of skill in the art. It will be appreciated that the processors and memory may be configured to store, host and/or execute one or more user applications or other software modules. These applications may include, but not be limited to, for example, any type of computation, communication, data management, data storage and/or user interface task. In some embodiments, these applications may employ or interact with any other components of the mobile platform 610.

System 600 is also shown to include network interface module 640 which may include wireless communication capabilities, such as, for example, cellular communications, Wireless Fidelity (WiFi), Bluetooth®, and/or Near Field Communication (NFC). The wireless communications may conform to or otherwise be compatible with any existing or yet to be developed communication standards including past, current and future version of Bluetooth®, Wi-Fi and mobile phone communication standards.

System 600 is also shown to include an input/output (IO) system or controller 650 which may be configured to enable or manage data communication between processors 104, 106, 620 and other elements of system 600 or other elements (not shown) external to system 600.

System 600 is also shown to include processor state control module 102 and producer/consumer workload estimation module 108, as described previously. It will be appreciated that in some embodiments, the various components of the system 600 may be combined in a system-on-a-chip (SoC) architecture. In some embodiments, the components may be hardware components, firmware components, software components or any suitable combination of hardware, firmware or software.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as, for example, processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may include, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides systems, devices, methods and computer readable media for controlling the processor state (e.g., the clock frequency) of processors based on detection of producer/consumer workload serialization across the processors. The following examples pertain to further embodiments.

According to Example 1 there is provided a system for controlling clock frequency of processors. The system may include a utilization measurement module to measure utilization of the processors. The system of this example may also include

a correlation module to estimate a balance between producer/consumer (P/C) workload and non-P/C workload executing on the processors. The system of this example may further include a clock frequency adjustment module to calculate a clock frequency adjustment based on the estimated balance and the measured utilization and to update the clock frequency of the processors based on the calculated adjustment.

Example 2 may include the elements of the foregoing example, and the correlation module is further configured to: change the clock frequency for a period of time associated with the balance estimation; measure utilization change during the period of time; and estimate the balance based on a ratio of the utilization change to the clock frequency change.

Example 3 may include the elements of the foregoing example, and the clock frequency change is a clock frequency increase.

Example 4 may include the elements of the foregoing example, and the clock frequency change is a clock frequency decrease.

Example 5 may include the elements of the foregoing example, and the correlation module is further configured to compare the ratio to a threshold ratio and associate the balance with the P/C workload if the ratio is less than the threshold ratio.

Example 6 may include the elements of the foregoing example, and the clock frequency adjustment is a clock frequency increase if the estimated balance is associated with a P/C workload and if the measured utilization is less than a utilization threshold.

Example 7 may include the elements of the foregoing example, and the utilization measurement module is further configured to re-measure utilization of the processors after an elapsed time interval; and the clock frequency adjustment module is further configured to decrease the clock frequency if the re-measured utilization is greater than the utilization threshold and if the clock frequency adjustment was a clock frequency increase.

Example 8 may include the elements of the foregoing example, and the updating of the clock frequency further includes adjusting a voltage-frequency pairing of a control state of the processors.

Example 9 may include the elements of the foregoing example, and the processors are processor cores and/or graphics processing units (GPUs).

Example 10 may include the elements of the foregoing example, and the system is incorporated in a smart phone, smart tablet, notebook or laptop computer.

According to Example 11 there is provided a method for controlling clock frequency of processors. The method may include measuring utilization of the processors. The method of this example may also include estimating balance between producer/consumer (P/C) workload and non-P/C workload executing on the processors. The method of this example may further include calculating a clock frequency adjustment based on the estimated balance and the measured utilization. The method of this example may further include updating the clock frequency of the processors based on the calculated adjustment.

Example 12 may include the operations of the foregoing example, and the balance estimation further includes: changing the clock frequency for a period of time associated with the balance estimation; measuring utilization change during the period of time; and estimating the balance based on a ratio of the utilization change to the clock frequency change.

Example 13 may include the operations of the foregoing example, and the clock frequency change is a clock frequency increase.

Example 14 may include the operations of the foregoing example, and the clock frequency change is a clock frequency decrease.

Example 15 may include the operations of the foregoing example, and further include comparing the ratio to a threshold ratio and associating the balance with the P/C workload if the ratio is less than the threshold ratio.

Example 16 may include the operations of the foregoing example, and the clock frequency adjustment is a clock frequency increase if the estimated balance is associated with a P/C workload and if the measured utilization is less than a utilization threshold.

Example 17 may include the operations of the foregoing example, and further include: re-measuring utilization of the processors after an elapsed time interval; and decreasing the clock frequency if the re-measured utilization is greater than the utilization threshold and if the clock frequency adjustment was a clock frequency increase.

Example 18 may include the operations of the foregoing example, and the updating of the clock frequency further includes adjusting a voltage-frequency pairing of a control state of the processors.

Example 19 may include the operations of the foregoing example, and the processors are processor cores and/or graphics processing units (GPUs).

According to Example 20 there is provided a system for controlling clock frequency of processors. The system may include means for measuring utilization of the processors. The system of this example may also include means for estimating balance between producer/consumer (P/C) workload and non-P/C workload executing on the processors. The system of this example may further include means for calculating a clock frequency adjustment based on the estimated balance and the measured utilization. The system of this example may further include means for updating the clock frequency of the processors based on the calculated adjustment.

Example 21 may include the elements of the foregoing example, and the balance estimation further includes: means for changing the clock frequency for a period of time associated with the balance estimation; means for measuring utilization change during the period of time; and means for estimating the balance based on a ratio of the utilization change to the clock frequency change.

Example 22 may include the elements of the foregoing example, and the clock frequency change is a clock frequency increase.

Example 23 may include the elements of the foregoing example, and the clock frequency change is a clock frequency decrease.

Example 24 may include the elements of the foregoing example, and further include means for comparing the ratio to a threshold ratio and means for associating the balance with the P/C workload if the ratio is less than the threshold ratio.

Example 25 may include the elements of the foregoing example, and the clock frequency adjustment is a clock frequency increase if the estimated balance is associated with a P/C workload and if the measured utilization is less than a utilization threshold.

Example 26 may include the elements of the foregoing example, and further include: means for re-measuring utilization of the processors after an elapsed time interval; and means for decreasing the clock frequency if the re-measured utilization is greater than the utilization threshold and if the clock frequency adjustment was a clock frequency increase.

Example 27 may include the elements of the foregoing example, and the updating of the clock frequency further includes means for adjusting a voltage-frequency pairing of a control state of the processors.

Example 28 may include the elements of the foregoing example, and the processors are processor cores and/or graphics processing units (GPUs).

According to another example there is provided at least one computer-readable storage medium having instructions stored thereon which when executed by a processor, cause the processor to perform the operations of the method as described in any of the examples above.

According to another example there is provided an apparatus including means to perform a method as described in any of the examples above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A system for controlling clock frequency of processors, said system comprising:
a utilization measurement module to measure utilization of said processors;
a correlation module to estimate a balance between producer/consumer (P/C) workload and non-P/C workload executing on said processors; and
a clock frequency adjustment module to calculate a clock frequency adjustment based on said estimated balance and said measured utilization and to update said clock frequency of said processors based on said calculated adjustment.

2. The system of claim 1, wherein said correlation module is further to:
change said clock frequency for a period of time associated with said balance estimation;
measure utilization change during said period of time; and
estimate said balance based on a ratio of said utilization change to said clock frequency change.

3. The system of claim 2, wherein said correlation module is further to compare said ratio to a threshold ratio and associate said balance with said P/C workload if said ratio is less than said threshold ratio.

4. The system of claim 1, wherein said clock frequency adjustment is a clock frequency increase if said estimated balance is associated with a P/C workload and if said measured utilization is less than a utilization threshold.

5. The system of claim 4, wherein said utilization measurement module is further to re-measure utilization of said processors after an elapsed time interval; and said clock frequency adjustment module is further to decrease said clock frequency if said re-measured utilization is greater than said utilization threshold and if said clock frequency adjustment was a clock frequency increase.

6. The system of claim 1, wherein said updating of said clock frequency further comprises adjusting a voltage-frequency pairing of a control state of said processors.

7. The system of claim 1, wherein said processors are processor cores and/or graphics processing units (GPUs).

8. The system of claim 1, wherein said system is incorporated in a smart phone, smart tablet, notebook or laptop computer.

9. A method for controlling clock frequency of processors, said method comprising:
measuring utilization of said processors;
estimating balance between producer/consumer (P/C) workload and non-P/C workload executing on said processors;
calculating a clock frequency adjustment based on said estimated balance and said measured utilization; and
updating said clock frequency of said processors based on said calculated adjustment.

10. The method of claim 9, wherein said balance estimation further comprises:
changing said clock frequency for a period of time associated with said balance estimation;
measuring utilization change during said period of time; and
estimating said balance based on a ratio of said utilization change to said clock frequency change.

11. The method of claim 10, further comprising comparing said ratio to a threshold ratio and associating said balance with said P/C workload if said ratio is less than said threshold ratio.

12. The method of claim 9, wherein said clock frequency adjustment is a clock frequency increase if said estimated balance is associated with a P/C workload and if said measured utilization is less than a utilization threshold.

13. The method of claim 12, further comprising:
re-measuring utilization of said processors after an elapsed time interval; and
decreasing said clock frequency if said re-measured utilization is greater than said utilization threshold and if said clock frequency adjustment was a clock frequency increase.

14. The method of claim 9, wherein said updating of said clock frequency further comprises adjusting a voltage-frequency pairing of a control state of said processors.

15. The method of claim 9, wherein said processors are processor cores and/or graphics processing units (GPUs).

16. At least one computer-readable storage medium having instructions stored thereon which when executed by a processor result in the following operations for controlling clock frequency of processors, said operations comprising:
measuring utilization of said processors;
estimating balance between producer/consumer (P/C) workload and non-P/C workload executing on said processors;
calculating a clock frequency adjustment based on said estimated balance and said measured utilization; and
updating said clock frequency of said processors based on said calculated adjustment.

17. The computer-readable storage medium of claim 16, wherein said balance estimation further comprises the operations of:
changing said clock frequency for a period of time associated with said balance estimation;
measuring utilization change during said period of time; and
estimating said balance based on a ratio of said utilization change to said clock frequency change.

18. The computer-readable storage medium of claim 17, further comprising the operations of comparing said ratio to a threshold ratio and associating said balance with said P/C workload if said ratio is less than said threshold ratio.

19. The computer-readable storage medium of claim 16, wherein said clock frequency adjustment is a clock frequency increase if said estimated balance is associated with a P/C workload and if said measured utilization is less than a utilization threshold.

20. The computer-readable storage medium of claim 19, further comprising the operations of:
re-measuring utilization of said processors after an elapsed time interval; and
decreasing said clock frequency if said re-measured utilization is greater than said utilization threshold and if said clock frequency adjustment was a clock frequency increase.

21. The computer-readable storage medium of claim 16, wherein said updating of said clock frequency further comprises the operation of adjusting a voltage-frequency pairing of a control state of said processors.

22. The computer-readable storage medium of claim 16, wherein said processors are processor cores and/or graphics processing units (GPUs).
